(19) United States
(12) Patent Application Publication
(10) Pub. No.: US 2007/0009425 A1
(43) Pub. Date: Jan. 11, 2007

(54) Method for producing alkali metal hydrides and hydrogen

(76) Inventor: Wolf Johnssen, Munich (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/558,585

(22) PCT Filed: May 26, 2004
(86) PCT No.: PCT/EP04/05676

§ 371 Date: Nov. 28, 2005

(30) Foreign Application Priority Data
May 27, 2003 (DE) 103 24 082.9

(51) Int. Cl. C01B 6/04

(52) U.S. Cl. 423/646; 423/648.1

(57) ABSTRACT

The invention relates to a method for producing hydrogen, comprising: (i) reacting an alkali metal compound with a carbon-containing substance and hydrogen to obtain an alkali metal hydride; and (ii) reacting the alkali metal hydride that has been obtained with water to obtain hydrogen and alkali metal hydroxide. The invention also relates to a method comprising the steps of: (a) reacting a carbon source with water to obtain a carbon-containing substance; and (b) reacting the carbon-containing substance that has been obtained with hydrogen and an alkali metal compound to obtain an alkali metal hydride. In another embodiment a method is described comprising the steps of: (a) reacting a carbon source with water to obtain hydrogen; and (b) reacting the hydrogen that has been obtained with a carbon-containing substance and an alkali metal compound to obtain an alkali metal hydride.

The present invention relates to a method for producing hydrogen and a method for producing an alkali metal hydride. The obtained alkali metal hydride can in turn be used to obtain hydrogen and alkali metal hydroxide or hydrogen and alkali metal.

The use of hydrogen as an energy source has been studied intensively for some years. For its use as an energy source, hydrogen has to be stored and provided to the consumer.

Up to now, hydrogen has for example been provided in liquid form. However, due to the low boiling point of hydrogen, the energy consumption for liquefying and storing it at low temperatures is very high. Although hydrogen can be stored at room temperature in the form of a compressed gas, the energy consumption for compressing is quite high as well. Furthermore, the storage density is not yet sufficient. Both in the case of liquid hydrogen and compressed hydrogen, there can be losses due to evaporation. Moreover, there are still significant problems with safety and handling so that these forms of provision are not suitable for private households.

Hydrogen can also be provided in the form of metal hydrides, such as special FeTi or TiVFeMn alloys, which reversibly store hydrogen and then release it at the desired time.

In addition to reversible systems, irreversible storage concepts have been presented as well. According to these concepts metal hydrides are hydrolyzed with water, whereby hydrogen is formed. US-B-6,534,033 and US-B-6,497,973 describe systems based on boron hydride.

US-A-5,728,464 and US-A-5,817,157 describe the production of hydrogen from alkali metal or alkali metal hydride. In order to prevent a premature reaction of alkali metal or alkali metal hydride with atmospheric moisture during storage, the alkali metal or alkali metal hydride is provided with a coating e.g. of aluminum or plastic. It is an object of the present invention to provide an environmentally friendly method for providing hydrogen.

Another object of the present invention is to describe an environmentally friendly method for providing alkali metal hydrides.

In one embodiment the invention relates to a method for producing hydrogen comprising:
(i) reacting an alkali metal compound with a carbon-containing substance and hydrogen to obtain an alkali metal hydride; and
(ii) reacting the alkali metal hydride that has been obtained with water to obtain hydrogen and alkali metal hydroxide.

In another embodiment the invention relates to a method comprising the steps of:
(a) reacting a carbon source with water to obtain a carbon-containing substance; and
(b) reacting the carbon-containing substance that has been obtained with hydrogen and an alkali metal compound to obtain an alkali metal hydride.

A method comprising the steps of:
(a) reacting a carbon source with water to obtain hydrogen; and
(b) reacting the hydrogen that has been obtained with a carbon-containing substance and an alkali metal compound to obtain an alkali metal hydride is also subject-matter of the invention.

In yet another embodiment, the invention relates to a method comprising the steps of:
(i) reacting an alkali metal compound with a carbon-containing substance and hydrogen to obtain an alkali metal hydride; and
(ii) converting the alkali metal hydride that has been obtained to alkali metal and hydrogen.

The methods of the present invention are especially environmentally friendly. Preferably, renewable energy sources and starting compounds of biomass can be used.

The embodiments of the invention are described below.

Alkali Metal Compound

The alkali metal compound can be any alkali metal compound which can be reacted with a carbon-containing substance in the presence of hydrogen to an alkali metal hydride. Examples of alkali metal compounds are alkali metal carbonates, alkali metal oxides and alkali metal hydroxides. Preferably, alkali metal hydroxides are used.

Any alkali metal can be used in the alkali metal compound. Preferably, lithium, sodium and potassium compounds are used. Due to the high weight ratio of hydrogen to alkali metal, lithium compounds are preferably selected.

Carbon-Containing Substanc

The carbon-containing substance is not particularly restricted, either, as long as it is able to react the alkali metal compound in the presence of hydrogen to an alkali metal hydride. The carbon-containing substance can contain carbon per se, an organic carbon-containing compound, such as hydrocarbons, and mixtures thereof. Examples of carbon-containing substances are coal, coke, petroleum, natural gas, and hydrocarbons with 1 to 20 carbon atoms, such as methane, propane or butane. Preferably, coal, coke and hydrocarbons with 1 to 6 carbon atoms are used. In a preferred embodiment, coke, particularly biogenous coke, is used.

The biogenous coke can be biogenous coke which can be prepared from biomass in various ways. The term biomass is to be understood as meaning all carbon-containing substrates which comprise components of animal or vegetable origin and which can be converted to coke. Examples of biomass are wood and wood-containing substrates (e.g. wood, sawdust, wood scraps, and the like), paper and precursors or residual material from the papermaking process (e.g. paper scraps, cardboard; residual material and precursors from the papermaking process, including black liquor and the like), substrates of vegetable origin (e.g. plant clippings, energy grass, agricultural waste, and the like), substrates of animal origin (e.g. slaughterhouse waste, animal waste, and the like), as well as other substrates (e.g. residual material from the food industry, residual material from anaerobic gasification, communal and optionally industrial sewage sludge, and the like).

According to one embodiment, biogenous coke can be produced in a rotary kiln or a multi-story Herreshoff furnace by heating in the absence of air at 400 to 500° C. Acetic acid, methanol, acetone and pyrolysis gas are formed as by-products. The formed pyrolysis gas can be processed further as described below or burned by adding fossil fuels to heat the furnace.

The carbon-containing substance can be obtained by reacting a carbon source with water. For this purpose, in particular, gasification and reaction under critical conditions are suitable processes.

In one embodiment, coke can be produced by gasification, in particular of biomass. In a gasification, a carbon source is reacted with water (preferably water vapor). As is described below, depending on the employed process conditions, a carbon-containing substance, hydrogen, or a mixture of the two is obtained as the main product. In the present invention, low-temperature gasification is preferred. In this process, autothermic (air and water vapor) gasifiers or allothermic (water vapor) gasifiers can be used. It has surprisingly been found that coke produced by gasification, in particular gasification of biomass, is especially reactive in the reaction with the alkali metal compound and hydrogen and leads to a higher yield of alkali metal hydride compared with other carbon-containing substances, especially compared with other types of coke.

Hydrogen

The hydrogen used can also come from different sources. The hydrogen can for example be obtained from the electrolysis of water, reforming, the reaction of a carbon source with water (e.g. gasification or the reaction of a carbon source with water under critical conditions), or from the shift reaction.

The electrolysis of water is already being carried out on an industrial scale. In a preferred embodiment, the electricity needed for electrolysis is provided by wind power. Wind power plants are environmentally friendly since they make use of the natural power of the wind and do not create any waste gases or waste products. However, the amount of electricity generated depends on the current wind conditions and cannot be controlled according to demand. For these reasons, it is problematic to feed electricity from wind farms into the general power supply network. The use of electricity from wind power for the production of alkali metal hydrides offers the possibility of storing the energy in a stable and storable form. In another embodiment, the electricity needed for electrolysis can be generated by solar energy since this electricity is subject to fluctuations depending on the solar radiation. In this case as well, the method of the present invention offers the possibility of storing the energy generated by solar power in the form of alkali metal hydride. Of course, other conventional or alternative sources of energy, such as water power, can be used as well.

Reforming processes as well as the production of hydrogen from natural gas are currently also carried out on a large scale to produce hydrogen.

In another preferred embodiment, gasification can be used to provide hydrogen. In a gasification, a carbon-containing substance is reacted with water (preferably water vapor) and optionally oxygen or air. As examples of carbon-containing substances those mentioned above as well as biomass can be mentioned. In view of the environmental compatibility of the method, gasification of biomass is advantageous.

The gasification of biomass (or other carbon-containing substances) is for example carried out by means of autothermic or allothermic gasification processes. Depending on the employed gasification conditions, pyrolysis gas and/or coke are produced when the biomass is heated. First, a mixture of carbon monoxide, carbon dioxide, hydrogen, hydrocarbons (e.g. methane and higher hydrocarbons) and tar substances is obtained as a raw pyrolysis gas. The hydrocarbons are gasified further, forming carbon monoxide, carbon dioxide and hydrogen. The hydrogen can be separated from this mixture using known methods. Optionally, the hydrogen yield can be increased further by a shift reaction. A residual gas remains as a by product which can be used for the generation of heat. The generated heat can for example be used in the reaction of the carbon source with water or in the reaction of the alkali metal compound to an alkali metal hydride. Alternatively, it can be used for other purposes, for example the electricity or heat supply.

The gasification of the pyrolysis gases, which are formed during the heating of biomass, basically requires less thermal energy than the gasification of the resulting coke. Pyrolysis gases are formed when the biomass fed is heated to above approximately 350° C., and they gasify within seconds at higher gasifier temperatures, both in autothermic and allothermic reaction modes. The dwell time of pyrolysis coke in the reactor on the other hand has to be several hours in order to be able to achieve a complete reaction. Therefore, when the heat supply is limited and because of the more rapid kinetics, the gasification of pyrolysis gas is preferred. Thus, by adjusting the temperature, dwell time and throughput of biomass, the gasification can be carried out such that mainly hydrogen, mainly coke, or a mixture of both is formed during gasification. If mainly hydrogen is formed, the method of the present invention can be carried out with the biogenous hydrogen and with a carbon-containing substance from another source. If mainly coke is formed, the method of the present invention can be carried out with the biogenous coke and with hydrogen from another source. In an especially preferred embodiment, both the hydrogen and the carbon-containing substance are produced by gasification, in particular of biomass. Both starting substances can then be produced in one step.

Suitable gasifiers are commercially available for example from the companies CHOREN (Freiberg, Saxony, Germany), MTCI/TCI (U.S.A.) and FERCO (U.S.A.). Most biomass gasifiers are fluidized bed gasifiers. Mainly hydrogen-containing pyrolysis gases are formed at temperatures of 750 to 850° C. When the temperature is lowered to below about 600° C., the coke formed in the reactor as an intermediate product is no longer gasified but is obtained as a product in connection with hydrogen-containing pyrolysis gases.

In allothermic (water vapor) gasifiers, the process heat is provided externally and is introduced into the fluidized bed by means of a heat carrier medium or special heat exchangers.

In the Battelle Columbus process (reactors are commercially available from the company FERCO), non-gasified pyrolysis coke, which is removed from the reactor together with the fluidized bed sand, is burned in a separate reactor. Then the heated sand is re-introduced into the reactor. Due to the limited heat capacities, the circulating amounts and temperatures of the sand or another solid heat carrier medium, the charged heat flow is limited and is not sufficient for gasifying the pyrolysis coke. These and similar processes in which heat is introduced into a fluidized bed by means of heated steel or corundum spheres can be referred to as “partial steam reforming” since only a partial gasification with water vapor takes place.

In “complete steam reforming” processes, special heat exchangers with a particularly high specific heat density (e.g. at least 150 watt/° C.·m²) have to introduce so much heat into the fluidized bed that the coke can be gasified as well. The vapor with a temperature of 600 to 650° C. fed as reaction and fluidizing medium can serve as a second heat source. Such gasifiers are available from ThermoChem, Inc. (Baltimore, U.S.A).

Apart from autothermic and allothermic gasification processes, processes for reacting a carbon source with water under critical conditions (pressure and/or temperature) can be used. Carbon, liquid and gaseous hydrocarbons as well as hydrogen can be obtained as products, which can be used in the reaction of the alkali metal compound.

An improvement in the hydrogen yield, in particular in the case of biomass, can be achieved if an alkali metal compound (for example carbonate, sulfide or hydroxide; preferably hydroxide) is added to the gasification process. Preferably, the alkali metal compound is added in an amount of 5 to 10 weight-%, based on the weight of the carbon source. The addition of the alkali metal compound reduces the amount of long-chain hydrocarbons contained in the final products and thus leads to an increased hydrogen yield.

A particular advantage of the use of renewable energy sources such as biomass, wind power, water power, solar power and the like in the production of the starting compounds of the reaction is that compared to conventional processes the hydrogen production can be carried out in a CO₂-reduced or CO₂-neutral manner.

The alkali metal compound, the carbon-containing substance and hydrogen are reacted to alkali metal hydride in a carbothermal process. Such carbothermal processes are known and described for example in US-A-2,884,311. The approach described in this patent is incorporated herein by reference. However, the method of the present invention is not restricted to this specific approach. Rather, the starting compounds are reacted at about 600 to 850° C. Thus, the required temperatures are significantly lower than the temperatures necessary for the production of alkali metal using carbothermal processes. This results in reduced costs both for carrying out the process and the acquisition of the reactors, and it guarantees undisrupted long term operation.

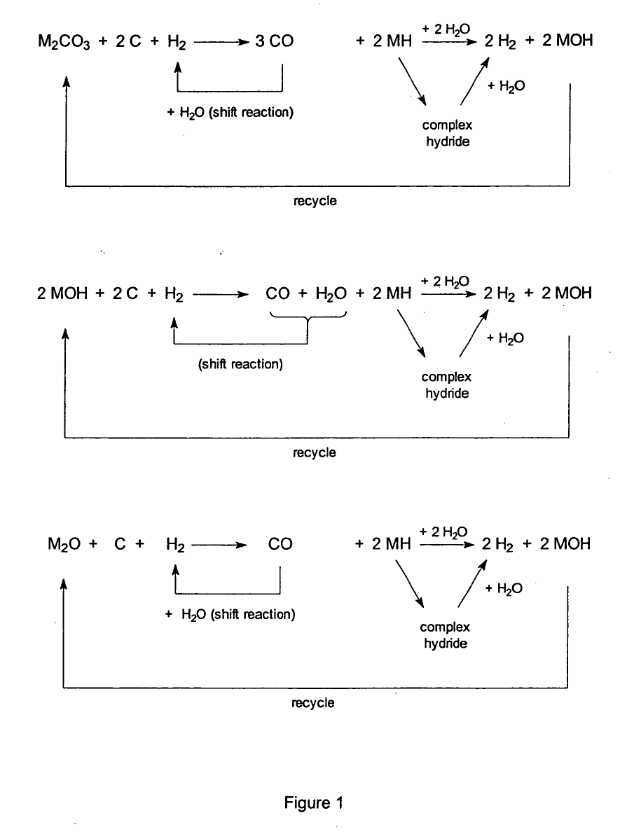

The reaction is explained in FIG. 1, using alkali metal carbonates, alkali metal hydroxides and alkali metal oxides as an example, whereby M represents alkali metal. Alkali metal hydride, carbon monoxide and optionally water are formed as reaction products. The carbon monoxide formed in the reaction can be reacted with oxygen (for example atmospheric oxygen) to carbon dioxide:
CO+½ O₂→CO₂

The heat released in this reaction can be used to heat the mixture in the carbothermal method. This way, energy can be saved. It is also possible to react the resulting carbon monoxide with water vapor in a shift reaction to hydrogen and carbon dioxide:
CO+H₂O→CO₂+H₂

The hydrogen can in turn be used as a starting material in the carbothermal process.

Both the oxidation of carbon monoxide to carbon dioxide and the shift reaction can be carried out according to known methods.

The heat necessary for carrying out the carbothermal process can be generated by various processes either alone or in combination. Apart from using the heat released during the reaction of carbon monoxide to carbon dioxide, heat can be supplied via electric heating or other processes (e.g. heat of combustion, process heat from other processes etc.). If electric heating is chosen, the electricity used for this purpose preferably comes from wind, water or solar power. Alternatively, hydrogen and oxygen can be fed into the reactor, e.g. from an electrolyzer, for the reaction of the alkali metal compound with the carbon-containing substance and hydrogen. There, the oxygen reacts with the carbon monoxide formed in the reaction and/or with hydrogen and generates heat for the endothermic reaction.

The alkali metal hydride obtained in the carbothermal process can be stored until the production of hydrogen is desired. This way, the production of alkali metal hydride can be decoupled from the production of hydrogen with respect to both time and location. For example, alkali metal hydride can be produced centrally, while hydrogen is produced individually by the consumer. Depending on the requirements of the production plant, alkali metal hydride can either be produced continuously or only when sufficient energy is available (e.g. wind power plants, solar power plants), so that the method of the present invention is optimally adapted to various demands.

The alkali metal hydride can either be stored as such, in the form of coated pieces, such as for example described in US-A-5,728,464 or US-A-5,817,157, or in any other form prior to the production of hydrogen.

If desired, the alkali metal hydride obtained in the carbothermal process can be reacted to form a complex hydride prior to hydrolysis. Complex hydrides are hydrides with alkali metal and at least one other element. Examples include boron-and aluminum-containing hydrides. They can be prepared from the alkali metal hydride according to known methods, such as the Schlesinger process, and be hydrolyzed afterwards (optionally after storage) on demand.

The processes for carrying out the hydrolysis of the alkali metal hydrides or the complex hydrides are not particularly restricted and depend on the use of the hydrogen. In the case of a motor vehicle, for example, the hydrogen has to be provided depending on the high fluctuations of load, whereas if it is used in a fuel cell, it should rather be provided at a constant rate. Hydrolysis processes are known in the corresponding technical fields. Optionally, the hydrogen can be released on the desired pressure level.

The hydrogen that has been obtained can be used in all conventional fields of application. Examples are powder metallurgy, the food industry, the manufacture of cosmetics and pharmaceuticals, hydrogen fueling stations, hydrogen-powered vehicles, fuel cells and the like. If desired, the hydrogen can be compressed or liquefied.

In addition to hydrogen, alkali metal hydroxide in the form of an aqueous solution results in the hydrolysis reaction. The alkali metal hydroxide by-product can be used for another purpose or can be recirculated into the carbothermal process after an appropriate work-up. In the case of hydroxides as alkali metal compounds, the aqueous alkali metal hydroxide solution merely has to be evaporated which makes processing especially simple. For other alkali metal compounds as starting materials in the carbothermal process additional steps have to be carried out to convert the alkali metal hydroxide to the corresponding alkali metal compound.

The recirculation of the alkali metal hydroxide into the carbothermal process avoids waste and renders the process especially environmentally friendly. Furthermore, relatively limited mineral deposits, e.g. lithium deposits, are protected by reusing (recycling) the substances in the process.

A possible application of the method according to the present invention can be explained using the example of a hydrogen fueling station. However, the method of the present invention is not restricted to this application. Analogously, the method of the present invention can be used for hydrogen-powered motor vehicles, fuel cells, and in the other application fields mentioned above.

Alkali metal hydride is produced according to the present invention and is supplied to a hydrogen fueling station for example in the form of pellets, which are optionally coated. There, it can first be stored until it is hydrolyzed to produce hydrogen on demand, e.g. when a motor vehicle has to be refueled. The hydrogen is filled into the tank of the motor vehicle. The aqueous solution of alkali metal hydroxide which is formed can be collected and subsequently returned to the manufacturer of the alkali metal hydride.

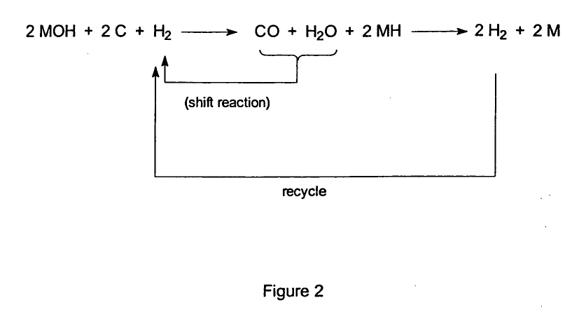

In another embodiment, instead of hydrolyzing the alkali metal hydride it can be thermally converted to alkali metal and hydrogen. This embodiment is illustrated in FIG. 2, using alkali metal hydroxide as an example. This variation of the method according to the present invention allows an environmentally friendly production of alkali metal while hydrogen is produced at the same time. The above explanations regarding the reaction of an alkali metal compound with a carbon-containing substance and hydrogen analogously apply to this embodiment. The thermal conversion of alkali metal hydride to alkali metal and hydrogen can be carried out according to known methods. The temperature of the thermal conversion depends on the employed alkali metal hydride and can be appropriately selected by the person skilled in the art.

The hydrogen needed for the process can be produced by a shift reaction from the carbon monoxide and water vapor obtained in the production of alkali metal hydride. In another embodiment, the carbon monoxide can be reacted with oxygen (for example atmospheric oxygen) to carbon dioxide, and the heat generated can be used in the thermal conversion of the alkali metal hydride to alkali metal and hydrogen. It is also possible to recirculate the hydrogen obtained in the conversion of alkali metal hydride to alkali metal and to use it in the production of alkali metal hydride as a starting material.

1. A method for producing hydrogen comprising the steps of:
(i) reacting an alkali metal compound with a carbon-containing substance and hydrogen to obtain an alkali metal hydride; and
(ii) reacting the alkali metal hydride that has been obtained with water to obtain hydrogen and alkali metal hydroxide.

2. The method according to claim 1, wherein in addition carbon monoxide is obtained in step (i).

3. The method according to claim 2, further comprising the steps (iii) reacting the carbon monoxide with oxygen and (iv) supplying the resulting reaction heat to step (i).

4. The method according to claim 2, comprising the steps (v) reacting the carbon monoxide with water vapor to obtain carbon dioxide and hydrogen and (vi) supplying the resulting hydrogen to step (i).

5. The method according to claim 1, comprising the steps (vii) optionally converting the alkali metal hydroxide obtained in step (ii) to the alkali metal compound and (viii) supplying the alkali metal compound to step (i).

6. The method according to claim 1, wherein the alkali metal compound is an alkali metal carbonate, an alkali metal oxide or an alkali metal hydroxide.

7-9. (canceled)

10. The method according to claim 1, wherein the carbon-containing substance is biogenous coke.

11. The method according to claim 1, wherein the hydrogen is biogenous hydrogen.

12. The method according to claim 1, further comprising the steps (ix) reacting a carbon source with water to obtain a carbon-containing substance and (x) supplying the resulting carbon-containing substance to step (i).

13. The method according to claim 1, further comprising the steps (xi) reacting a carbon source with water to obtain hydrogen and (xii) supplying the resulting hydrogen to step (i).

14. The method according to claim 13, wherein in addition a carbon-containing compound is obtained in step (xi) and the obtained carbon-containing compound is supplied to step (i).

15. A method comprising the steps of:
(a) reacting a carbon source with water to obtain a carbon-containing substance; and
(b) reacting the carbon-containing substance that has been obtained with hydrogen and an alkali metal compound to obtain an alkali metal hydride.

16. The method according to claim 15, wherein step (a) comprises gasification or a reaction under critical conditions.

17. (canceled)

18. The method according to claim 15, wherein the reaction in step (a) comprises gasification in the presence of alkali metal hydroxide.

19. The method according to claim 15, wherein the carbon source is biomass.

20. The method according to claim 15, further comprising the step (c) reacting the alkali metal hydride obtained in step (b) with water to obtain hydrogen and alkali metal hydroxide.

21. The method according to claim 15, further comprising the step (d) converting the alkali metal hydride obtained in step (b) to alkali metal and hydrogen.

22. A method comprising the steps of:
(a) reacting a carbon source with water to obtain hydrogen; and
(b) reacting the hydrogen that has been obtained with a carbon-containing substance and an alkali metal compound to obtain an alkali metal hydride.

23. The method according to claim 22, wherein step (a) comprises gasification or a reaction under critical conditions.

24. (canceled)

25. The method according to claim 22, wherein in addition a carbon-containing substance is obtained in step (a).

26. The method according to claim 25, wherein the carbon-containing substance obtained in step (a) is used as carbon-containing substance in step (b).

27. The method according to claim 22, wherein the reaction in step (a) comprises gasification in the presence of alkali metal hydroxide.

28. The method according to claim 22, wherein the carbon source is biomass.

29. The method according to claim 22, further comprising the step (c) reacting the alkali metal hydride obtained in step (b) with water to obtain hydrogen and alkali metal hydroxide.

30. The method according to claim 22, further comprising the step (d) converting the alkali metal hydride obtained in step (b) to alkali metal and hydrogen.

31. A method comprising the steps of:
(i) reacting an alkali metal compound with a carbon-containing substance and hydrogen to obtain an alkali metal hydride; and
(ii) converting the alkali metal hydride that has been obtained to alkali metal and hydrogen.
